(19) United States
(12) Patent Application Publication
(10) Pub. No.: US 2026/0246620 A1
(43) Pub. Date: Aug. 20, 2026

(54) SERVER APPARATUS FOR PROCESSING HOMOMORPHIC ENCRYPTED MESSAGES AND METHODS THEREOF

(71) Applicant: CRYPTO LAB INC., Seoul (KR)

(72) Inventors: Guillaume Hanrot, Seoul (KR); Seonhong Min, Seoul (KR); Jai Hyun Park, Villeurbanne (FR); Alain Passelegue, Seoul (KR); Damien Stehle, Seoul (KR)

(21) Appl. No.: 19/539,625

(22) Filed: Feb. 13, 2026

(30) Foreign Application Priority Data
Feb. 14, 2025 (KR) 10-2025-0019164
Apr. 15, 2025 (KR) 10-2025-0048636
Jul. 28, 2025 (KR) 10-2025-0102574
Oct. 2, 2025 (KR) 10-2025-0145105
Jan. 23, 2026 (KR) 10-2026-0013662

(51) Int. Cl. H04L 9/08; H04L 9/06

(52) U.S. Cl. CPC H04L 9/0825; H04L 9/0618

(57) ABSTRACT

A server apparatus includes a communication interface configured to perform communication with a plurality of electronic apparatuses, memory storing at least one instruction and a first homomorphic ciphertext, and a processor configured to execute the at least one instruction, wherein the first homomorphic ciphertext is data homomorphically encrypted with a global public key corresponding to a global secret key, and wherein the processor is configured to: based on receiving individual bit-string ciphertexts obtained by homomorphically encrypting a random bit string from each of the plurality of electronic apparatuses, perform a homomorphic operation on the individual bit-string ciphertexts to generate a sparse secret-key ciphertext corresponding to a sparse secret key, and generate a first switching key for converting the first homomorphic ciphertext into a second homomorphic ciphertext corresponding to the sparse secret key based on the sparse secret-key ciphertext.

### TECHNICAL FIELD

Apparatuses and methods consistent with the disclosure relate to a server apparatus capable of generating and using a sparse secret key even in a threshold cryptographic environment in which a plurality of participants in a distributed manner a secret key.

### BACKGROUND ART

As communication technologies have advanced and the distribution of electronic apparatuses has become more widespread, continuous efforts have been made to maintain communication security between electronic apparatuses. Accordingly, encryption/decryption technologies have been used in most communication environments.

Homomorphic encryption, one of the encryption technologies, has recently been actively researched. According to homomorphic encryption, even if an operation is performed on ciphertext itself without decrypting encrypted information, the result identical to a value obtained by performing an operation on plaintext and then encrypting a corresponding result may be obtained. Therefore, various operations may be performed without decrypting the ciphertext.

However, if various operations, such as multiplication, are repeatedly performed on homomorphic ciphertext, noise within the ciphertext increases, reducing an effective plaintext space. Accordingly, when the effective plaintext space is reduced to below a certain size, it becomes difficult to perform meaningful operations. In such cases, bootstrapping may be performed to restore or expand the plaintext space of homomorphic ciphertext.

To efficiently perform bootstrapping, it is desirable to reduce the operation amount by designing a structure of a secret key used in the bootstrapping operation to be sparse. In conventional homomorphic encryption systems, a method has been primarily considered in which a trusted entity holds a single global secret key and generates and uses a corresponding sparse secret key.

Meanwhile, in threshold cryptographic environments in which a plurality of participants in a distributed manner a secret key, even if each participant individually generates a sparse key, it is difficult to guarantee that the global secret key, obtained by combining the individually generated keys, will maintain a sparse structure. That is, in a threshold cryptographic environment, there is a need for a technology capable of generating and utilizing a sparse secret key suitable for bootstrapping without exposing the global secret key.

### DISCLOSURE OF INVENTION

### Solution to Problem

Embodiments of the disclosure may address at least one of the problems and/or disadvantages described above and provide the advantages described below. Accordingly, embodiments of the disclosure provide a homomorphic cryptographic processing method and electronic apparatus capable of efficiently performing high-dimensional matrix operations.

The disclosure provides a server apparatus capable of generating and using a sparse secret key even in a threshold cryptographic environment in which a plurality of participants hold shares of a secret key.

Additional embodiments will be presented in the detailed description below, some of which will be apparent from the detailed description, and other embodiments may also be derived through learning from the presented embodiments.

In accordance with an aspect of the disclosure, a server apparatus includes: a communication interface configured to perform communication with a plurality of electronic apparatuses; memory storing at least one instruction and a first homomorphic ciphertext; and a processor configured to execute the at least one instruction, wherein the first homomorphic ciphertext is data homomorphically encrypted with a global public key corresponding to a global secret key; and wherein the processor is configured to: based on receiving individual bit-string ciphertexts obtained by homomorphically encrypting a random bit string from each of the plurality of electronic apparatuses, perform a homomorphic operation on the individual bit-string ciphertexts to generate a sparse secret-key ciphertext corresponding to a sparse secret key, and generate a first switching key for converting the first homomorphic ciphertext into a second homomorphic ciphertext corresponding to the sparse secret key based on the sparse secret-key ciphertext.

The processor may be configured to: homomorphically add received individual bit-string ciphertexts to generate a global random bit-string ciphertext corresponding to a sum of random bit strings provided by the plurality of electronic apparatuses; generate a mask-vector ciphertext corresponding to a mask vector for selecting a predetermined number of bits using the global random bit-string ciphertext; and generate the sparse secret-key ciphertext using the mask-vector ciphertext and the global random bit-string ciphertext; and wherein the mask vector is a vector in which only one of a plurality of components has a value and remaining components are set to zero.

The processor may be configured to: perform a homomorphic operation that applies a random sign to the mask-vector ciphertext to generate a sparse secret-key ciphertext having, as plaintext, a ternary vector in which only a predetermined number of components among a plurality of components have a value of one of {-1, 1} and remaining components have a value of zero.

The processor may be configured to: generate a plurality of mask-vector ciphertexts, and for each of the plurality of mask-vector ciphertexts, repeatedly perform homomorphic multiplication and homomorphic addition according to a corresponding random sign to generate the sparse secret-key ciphertext.

The processor may be configured to: generate a parameter representing a part of ciphertext coefficients corresponding to the sparse secret-key ciphertext; control the communication interface to transmit the parameter to the plurality of electronic apparatuses; and based on receiving partial decryption results from the plurality of electronic apparatuses, generate the first switching key and a second switching key for converting a second homomorphic ciphertext corresponding to the sparse secret key into a first homomorphic ciphertext corresponding to the global secret key based on the received partial decryption results and the sparse secret-key ciphertext.

The processor may be configured to: convert the first homomorphic ciphertext into the second homomorphic ciphertext using the first switching key; perform bootstrapping on the second homomorphic ciphertext; and convert a bootstrapped second homomorphic ciphertext into a first homomorphic ciphertext corresponding to a global secret key using the second switching key.

The sparse secret-key ciphertext is a homomorphic ciphertext represented by coefficients of at least one polynomial; and wherein the processor may be configured to: extract one or more coefficient values corresponding to a predetermined index among polynomial coefficients of the sparse secret-key ciphertext, and compute the parameter by performing at least one of a division operation by a predetermined scaling factor or a rounding operation on the extracted coefficient values.

The partial decryption results may include flood noise; and wherein the processor may be configured to: sum the partial decryption results, perform normalization and decoding on a sum result to compute an intermediate parameter, and generate the first switching key and the second switching key based on the sparse secret-key ciphertext and the intermediate parameter.

Each of the individual bit-string ciphertexts may be obtained by homomorphically encrypting a random bit string with the global public key.

Each of the individual bit strings may be a bit string having a predetermined number of bits, and may be sampled to have a statistically uniform distribution among individual bit strings provided by the plurality of electronic apparatuses.

In accordance with an aspect of the disclosure, a method of processing homomorphic ciphertext in a server apparatus includes: storing a first homomorphic ciphertext homomorphically encrypted with a global public key corresponding to a global secret key; receiving individual bit-string ciphertexts obtained by homomorphically encrypting a random bit string from each of a plurality of electronic apparatuses, performing a homomorphic operation on the individual bit-string ciphertexts to generate a sparse secret-key ciphertext corresponding to a sparse secret key; and generating a first switching key for converting the first homomorphic ciphertext into a second homomorphic ciphertext corresponding to the sparse secret key based on the sparse secret-key ciphertext.

The generating a sparse secret key may include: homomorphically adding received individual bit-string ciphertexts to generate a global random bit-string ciphertext corresponding to a sum of random bit strings provided by the plurality of electronic apparatuses; generating a mask-vector ciphertext corresponding to a mask vector for selecting a predetermined number of bits using the global random bit-string ciphertext; and obtaining the sparse secret-key ciphertext using the mask-vector ciphertext and the global random bit-string ciphertext; and wherein the mask vector is a vector in which only one of a plurality of components has a value and remaining components are set to zero.

The obtaining the sparse secret-key ciphertext may include: performing a homomorphic operation that applies a random sign to the mask-vector ciphertext to generate a sparse secret-key ciphertext having, as plaintext, a ternary vector in which only a predetermined number of components among a plurality of components have a value of one of {-1, 1} and remaining components have a value of zero.

The generating a mask-vector ciphertext may include: generating a plurality of mask-vector ciphertexts, and for each of the plurality of mask-vector ciphertexts, repeatedly performing homomorphic multiplication and homomorphic addition according to a corresponding random sign to generate the sparse secret-key ciphertext.

The method may further include: generating a parameter representing a part of ciphertext coefficients corresponding to the sparse secret-key ciphertext; transmitting the parameter to the plurality of electronic apparatuses, wherein the generating a first switching key comprises: generating the first switching key and a second switching key for converting a second homomorphic ciphertext corresponding to the sparse secret key into a first homomorphic ciphertext corresponding to the global secret key based on the received partial decryption results and the sparse secret-key ciphertext.

The method may include: converting the first homomorphic ciphertext into the second homomorphic ciphertext using the first switching key; performing bootstrapping on the second homomorphic ciphertext; and converting a bootstrapped second homomorphic ciphertext into a first homomorphic ciphertext corresponding to a global secret key using the second switching key.

The sparse secret-key ciphertext may be a homomorphic ciphertext represented by coefficients of at least one polynomial; and wherein the generating a parameter may include: extracting one or more coefficient values corresponding to a predetermined index among polynomial coefficients of the sparse secret-key ciphertext, and computing the parameter by performing at least one of a division operation by a predetermined scaling factor or a rounding operation on the extracted coefficient values.

The partial decryption results may include flood noise; and wherein the generating the first switching key may include: summing the partial decryption results, performing normalization and decoding on a sum result to compute an intermediate parameter, and generating the first switching key and the second switching key based on the sparse secret-key ciphertext and the intermediate parameter.

Each of the individual bit-string ciphertexts may be obtained by homomorphically encrypting a random bit string with the global public key; and wherein each of the individual bit strings may be a bit string having a predetermined number of bits, and may be sampled to have a statistically uniform distribution among individual bit strings provided by the plurality of electronic apparatuses.

In accordance with an aspect of the disclosure, a computer-readable recording medium includes a program for executing a method of processing homomorphic ciphertext, wherein the method includes: storing a first homomorphic ciphertext homomorphically encrypted with a global public key corresponding to a global secret key; receiving individual bit-string ciphertexts obtained by homomorphically encrypting a random bit string from each of a plurality of electronic apparatuses, performing a homomorphic operation on the individual bit-string ciphertexts to generate a sparse secret-key ciphertext corresponding to a sparse secret key; and generating a first switching key for converting the first homomorphic ciphertext into a second homomorphic ciphertext corresponding to the sparse secret key based on the sparse secret-key ciphertext.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating a structure of a network system according to an embodiment of the disclosure.

FIG. 2 is a block diagram illustrating a configuration of a server apparatus and an electronic apparatus according to at least an embodiment of the disclosure.

FIG. 3 is a sequence diagram illustrating a key generation operation according to an embodiment of the disclosure.

FIG. 4 is a diagram illustrating an operation for generating a random bit string according to an embodiment of the disclosure.

FIG. 5 is a diagram illustrating an operation for generating a mask vector ciphertext according to an embodiment of the disclosure.

FIG. 6 is a diagram illustrating an example of a homomorphic sampling operation for generating a sparse secret key according to an embodiment of the disclosure.

FIG. 7 is a diagram illustrating another example of a homomorphic sampling operation for generating a sparse secret key according to an embodiment of the disclosure.

FIG. 8 is a diagram illustrating an operation for generating a switching key according to an embodiment of the disclosure.

FIG. 9 is a diagram illustrating a method for processing homomorphic ciphertext according to an embodiment of the disclosure.

FIG. 10 is a diagram illustrating a bootstrapping processing method according to an embodiment of the disclosure.

FIG. 11 is a flowchart illustrating a key generating method according to an embodiment of the disclosure.

### MODE FOR INVENTION

Hereinafter, the disclosure will be described in detail with reference to the accompanying drawings. Encryption/decryption may be applied to an information (data) transmission process performed in the disclosure, if necessary, and all expressions describing the information (data) transmission process in the disclosure and claims should be interpreted as including cases of encryption/decryption even if not separately stated. In the disclosure, expressions, such as “transmission (delivery) from A to B”0r “A receiving from B” include transmission (delivery) or reception with another medium included therebetween, and does not necessarily express only what is directly transmitted (delivered) or received from A to B.

In the description of the disclosure, the order of each step should be understood as non-limiting unless the preceding step needs to be logically and temporally performed necessarily before the following step. In other words, except for the above exceptional cases, even if the process described as the following step is performed before the process described as the preceding step, the nature of the disclosure is not affected, and the scope should also be defined regardless of the order of the steps. In this specification, “A or B” is defined to mean not only selectively indicating either one of A and B, but also including both A and B. In addition, in the disclosure, the term “include” has a meaning encompassing further including other components in addition to elements listed as included.

In this disclosure, only essential components necessary for the description of the disclosure are described, and components unrelated to the essence of the disclosure are not mentioned. In addition, it should not be interpreted as an exclusive meaning that includes only the mentioned components, but should be interpreted as a non-exclusive meaning that may include other components.

In addition, in the disclosure, “value” is defined as a concept including a vector as well as a scalar value. In the disclosure, the expressions, such as “compute,” and “calculate” may be replaced by an expression that produces a result of the corresponding computation or calculation. In addition, unless otherwise stated, calculation of an encrypted message to be described below means a homomorphic operation. For example, addition to the homomorphic encrypted message refers to homomorphic addition to two homomorphic encrypted messages.

Mathematical calculation and computations of each step of the disclosure to be described below may be implemented as computer operations by the known coding method and/or coding designed to suit the disclosure.

Specific equations to be described below are illustratively described among possible alternatives, and the scope of the disclosure should not be construed as being limited to equations mentioned in the disclosure.

For convenience of description, in the disclosure, a notation is defined as follows.
a←D: select element (a) according to distribution (D)
s1, s2∈R: s1, s2: Each of S1 and S2 is an element belonging to set R
mod(q): Modular calculation with element q
└·┐: Round-off internal value

Hereinafter, various embodiments of the disclosure will be described in detail with reference to the accompanying drawings.

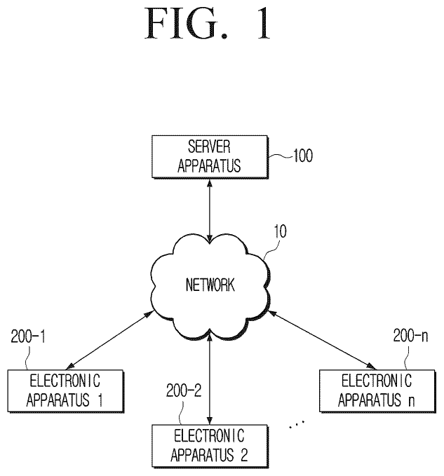

FIG. 1 is a diagram illustrating a structure of a network system according to an embodiment of the disclosure.

Referring to FIG. 1, a network system may include a server apparatus 100 and a plurality of electronic apparatuses 200-1 to 200-n, each of which may be interconnected via a network 10.

The network 10 may be implemented as various types of wired/wireless communication networks, broadcast communication networks, optical communication networks, cloud networks, etc. While FIG. 1 illustrates the devices 100 and 200-1 to 200-n being indirectly connected to each other via the network 10, but the disclosure is not limited thereto and each device may also be connected via methods, such as Wi-Fi, Bluetooth, or near-field communication (NFC) without a separate intermediary.

The server apparatus 100 is an apparatus for storing homomorphic ciphertext and performing various processing operations, such as computing the homomorphic ciphertext. The server apparatus 100 may be implemented as a single electronic apparatus or as a cloud server. In addition, the server apparatus 100 may be implemented as a web server accessible via the Internet, etc.

In FIG. 1, the server apparatus 100 is described so as to be distinguished from the electronic apparatuses 200-1 to 200-n. However, from another perspective, the server apparatus 100 may also be described as an electronic apparatus, and in this case, the other electronic apparatuses 200-1 to 200-n may be described as external devices.

The electronic apparatuses 200-1 to 200-n may be various terminal devices used by various users. Specifically, the electronic apparatuses 200-1 to 200-n may be implemented in various forms, such as PCs, laptop PCs, smartphones, tablet PCs, game players, home servers, and kiosks. In addition, the electronic apparatuses 200-1 to 200-n may be implemented as home appliances with IT functionality or as other server apparatuses.

Electronic apparatuses 200-1 to 200-n may generate various keys related to processing homomorphic ciphertext, convert a plaintext message into homomorphic ciphertext using the generated keys, and then transmit the homomorphic ciphertext and some of the keys to the server apparatus 100. Keys related to processing homomorphic ciphertext may include a public key, a secret key, an operation key, and a switching key.

Here, the secret key refers to a private key used to decrypt homomorphic ciphertext. In a threshold cryptographic environment, a global secret key may be generated and used for shared use by a plurality of participants (or users). Also, a sparse secret key used only during the bootstrapping process may be an example of the aforementioned secret key. Details of the sparse secret key used in this disclosure will be described below.

The public key is a key generated in response to the aforementioned secret key and is used to generate homomorphic ciphertext.

The operation key is an evaluation key used to perform homomorphic operations, such as rotation and relinearization, on homomorphic ciphertext.

The switching key is used in a key switching operation to convert a homomorphic ciphertext corresponding to a first secret key into a homomorphic ciphertext corresponding to a second secret key.

Here, “key switching” refers to an operation of converting a ciphertext generated with the first secret key (or a corresponding public key) so that it may be decrypted with the second secret key (or a corresponding public key). For example, key switching may be performed using an auxiliary key, such as a key switching key or a relinearization key, and the ciphertext obtained as a result of the key switching may be configured to represent the same plaintext as the ciphertext before the conversion.

For example, there may be a first switching key used in a switching operation of converting a homomorphic ciphertext decryptable with a global secret key sk into a homomorphic ciphertext decryptable with a sparse secret key sk′ and a second switching key used in a switching operation of converting a homomorphic ciphertext decryptable with a sparse secret key sk′ into a homomorphic ciphertext decryptable with a global secret key sk.

A user may input various information through the electronic apparatuses 200-1 to 200-n they use. The input information may be stored within the electronic apparatuses 200-1 to 200-n, but for reasons, such as storage capacity and security, the input information may also be transmitted to an external device, for example, the server apparatus 100 shown in FIG. 1, for storage. During transmission to an external device, data may be leaked to third parties, or an administrator of the external device may directly view or leak the data. Therefore, it is necessary to provide data that requires security, such as a user's personal information, to an external device after converting the data into an encrypted form to prevent third parties from identifying the data.

Since it is difficult to perform a meaningful operation on general ciphertext in an encrypted state, it is impossible for the server apparatus 100 storing the ciphertext to extract meaningful information from the ciphertext.

Accordingly, homomorphic encryption technology has been developed. That is, each electronic apparatus 200-1 to 200-n may homomorphically encrypt a plaintext message to convert it into homomorphic ciphertext and then transmit the homomorphic ciphertext to the server apparatus 100.

The server apparatus 100 may store the homomorphic ciphertext as is, and based on a calculation being required, the server apparatus 100 may perform calculation in the homomorphic ciphertext state and transmit the result of the operation to the party that requested the calculation.

For example, if the user of the first electronic apparatus 200-1 of FIG. 1 requests a calculation result for a specific homomorphic ciphertext, the server apparatus 100 may perform a homomorphic operation on the encrypted homomorphic ciphertext and transmit the homomorphically calculated ciphertext (i.e., the calculation result) to the first electronic apparatus 200-1. The first electronic apparatus 200-1 may decrypt the calculation result using a secret key and provide the user with the decrypted plaintext.

Each electronic apparatus 200-1 to 200-n may include encryption noise, i.e., errors, computed during a process of performing homomorphic encryption in the homomorphic ciphertext. For example, the homomorphic ciphertext generated by each electronic apparatus 200-1 to 200-n may be generated in a form that, based on being decrypted using a secret key, a result value, including a message and an error value, is generated in a restored form. The homomorphic encryption method that includes error values may be referred to as a CKKS method (or CKKS ciphertext).

For example, the homomorphic ciphertext generated by the electronic apparatuses 200-1 to 200-n may be generated in a form that satisfies the following properties when decrypted using a secret key:

$$Dec ( ct , sk ) = 〈 ct , sk 〉 = M + e ( mod q ) \qquad [ Equation 1 ]$$

Here, <, >denote a usual inner product, ct denotes a ciphertext, sk denotes a secret key, M denotes a plaintext message, e denotes an encrypted error value, and mod q denotes a modulus of the ciphertext. q should be chosen to be greater than the result of multiplying the message by the scaling factor Δ. If an absolute value of the error value e is sufficiently small compared to M, the decrypted value M+e of the ciphertext may replace the original message with the same precision in the significand calculation. In the decrypted data, the error may be located on the least significant bit (LSB), and M may be located on the next LSB.

Here, the scaling factor refers to a scale value applied to map a real or fixed-point value to the plaintext space of homomorphic encryption. For example, an input value may be multiplied by a scaling factor and then integerized to be encoded into a plaintext. Since the scale may change during a homomorphic encryption operation (especially multiplication), the scaling factor may be used in a rescaling or adjustment process to maintain decoding accuracy after the operation.

Each electronic apparatus 200-1 to 200-n may adjust the size of a message if it is too small or too large using the scaling factor. Using a scaling factor allows for the encryption of not only integer-type messages but also real-number-type messages, thereby significantly increasing versatility. In addition, by adjusting the size of a message using the scaling factor, the size of a region in which messages exist, that is, the size of a valid region, in a ciphertext after an operation is performed may also be adjusted.

According to an embodiment, the ciphertext modulus q may be set and used in various forms. For example, the modulus of the ciphertext may be set in the form of a power of the scaling factor Δ, q=ΔL. If Δ is 2, q=2¹⁰ may be set.

In addition, while the homomorphic ciphertext according to the disclosure is described assuming the use of fixed-point operation, the disclosure may also be applied to cases in which floating-point operation is used.

The server apparatus 100 may store homomorphic ciphertexts transmitted from each of the electronic apparatuses 200-1 to 200-n. In this state, the server apparatus 100 may perform operations on the stored homomorphic ciphertexts upon a user request or based on a specific event occurring.

In this case, the proportion occupied by the valid message and noise within the resulting ciphertext obtained from each operation varies. Consequently, if the noise proportion increases and the valid plaintext space becomes smaller than a threshold, it may be difficult to perform any further meaningful operations on the corresponding homomorphic ciphertext. This situation may be understood as a state in which a modulus level of the homomorphic ciphertext gradually decreases to below a preset threshold level.

Here, the modulus level refers to the size of the modulus used in the homomorphic encryption operation or a corresponding level thereof. As homomorphic encryption operations accumulate, noise within the ciphertext may increase, and the modulus level may indicate, for example, a current position of the modulus (or modulus chain) selected according to the operation step.

Based on the effective plaintext space decreasing below a threshold, the server apparatus 100 may perform a bootstrapping operation. Bootstrapping may be a process of resetting or restoring the modulus level of at least one homomorphic ciphertext.

For example, in Equation 1 described above, if q is less than M, M+e(mod q) has a different value from M+e, making decryption impossible. Therefore, the value q should always be greater than M. However, as the operation progresses, the modulus level corresponding to q gradually decreases. Therefore, an operation is required to ensure that the value q is always greater than M, and this operation is called a bootstrapping operation. As the bootstrapping operation is performed, the corresponding homomorphic ciphertext may be re-operated. In other words, the valid plaintext space within the homomorphic ciphertext exceeds a threshold.

While such bootstrapping has the advantage of enabling continuous computation of homomorphic ciphertexts, the computational load during this process may be very large, consuming significant time and resources. Here, the depth of a bootstrapping circuit is affected by the Hamming weight of a secret key corresponding to an input ciphertext. Accordingly, as the number of Is included in the secret key increases, the depth of the bootstrapping circuit becomes deeper and the level consumption increases.

Specifically, in the bootstrapping process, 30 rotation keys (rot keys), one conjugate key (conj key), and one multiplication key (mult key) are required, and these have a size of approximately 2 GB.

Here, the Hamming weight refers to the number of non-zero elements in a vector (or bit string). For example, in the case of a bit string, the number of bits with a value of 1 is called the Hamming weight. In this disclosure, “sparse” secret keys may mean that the Hamming weight of vectors constituting the secret key is relatively small compared to the overall dimension.

Therefore, for efficient bootstrapping, it is desirable to use a secret key with a low Hamming weight (e.g., approximately 31 or 32). To achieve this, a secret key of the homomorphic ciphertext may be key-switched to a sparse secret key before the bootstrapping process, and this operation may be called sparse key encapsulation.

For the key encapsulation, a key owner should provide two types of ciphertexts (or key switches). One is a key that converts a sparse secret key into a regular key (i.e., the second switching key described above), and the other is a key that converts the regular key into a sparse secret key (i.e., the first switching key described above). Using a sparse secret key in this manner enables faster and more efficient bootstrapping.

Meanwhile, electronic apparatuses may individually generate or process homomorphic ciphertext using different keys and may operate using a single secret key (or public key). For example, in a threshold, a plurality of electronic apparatuses may operate using a single secret key (or public key).

For example, in a threshold environment, the electronic apparatuses 200-1, 200-2, and 200-n have local secret keys, such as s1, s2, . . . s, respectively, and may generate a global secret key using the local secret keys. Here, the global secret key may be referred to as a global secret key, a common secret key, or a threshold secret key.

$$s = s 1 + s 2 , … + sn \qquad [ Equation 2 ]$$

Here, s is a global secret key. A global public key may be generated using the global secret key, and a homomorphic ciphertext may be encrypted with the global public key.

Accordingly, the homomorphic ciphertext generated using the aforementioned global public key requires the participation of a certain number or more of participants to perform secret operations, such as signing or key generation. That is, a threshold environment is a multiparty cryptographic environment in which no single participant may perform any operation on his/her own, and, for example, at least two out of three participants should collaborate to perform secret operations.

Even in such a threshold environment, bootstrapping is required during the operation of homomorphic ciphertexts, and it is necessary to use a sparse secret key for the efficient performance of the bootstrapping.

In particular, in a threshold homomorphic encryption environment, the secret key is distributed among a plurality of participants, reducing the risk of a single-device compromise. However, accuracy issues in bootstrapping do not merely result in reduced usability but may lead to security attacks (e.g., key recovery attacks based on the observation of bootstrapping failures). Therefore, sparse secret encapsulation (SSE) may be required as a method to sufficiently lower the bootstrapping failure probability without excessively degrading performance. Accordingly, there has been a demand for a secret key structure and a key switching design aimed at reducing the bootstrapping failure probability in a threshold environment

In this disclosure, “bootstrapping failure” may refer to a case in which the bootstrapping result fails to recover a plaintext within a preset error margin or fails to satisfy the validity of a resulting ciphertext. Reducing the bootstrapping failure probability may be important not only from a performance perspective but also from a security perspective.

However, as described above, since the global key is generated by summing the local secret keys of participants, even if each participant generates a sparse local secret key, there is no guarantee that the final generated global secret key will maintain its sparse structure. That is, if a global secret key is composed of the sum of a plurality of secret keys, it is difficult for the global secret key to maintain sparseness with a high probability, even if each individual secret key is sparse. In this case, the global secret key is not suitable for SSE, which may lead to reduced bootstrapping efficiency and a significant decrease in overall homomorphic operation throughput.

Also, conventional approaches for obtaining a sparse secret key in a threshold environment may often require complex multi-party computation procedures or settings or may require redesign/reconfiguration due to changes in the number of participants, resulting in high operational costs. Accordingly, there has been demand for a technology capable of generating and utilizing a sparse secret key through relatively simple procedures without exposing the global secret key.

To solve these problems, the disclosure utilizes a separate sparse secret key by homomorphically sampling it. For example, each of the electronic apparatuses 200-1 to 200-n may generate an individual bit ciphertext and provide the same to the server apparatus 100.

Also, the server apparatus 100 may perform a homomorphic operation on the provided individual bit ciphertexts to generate a sparse secret key ciphertext corresponding to the sparse secret key.

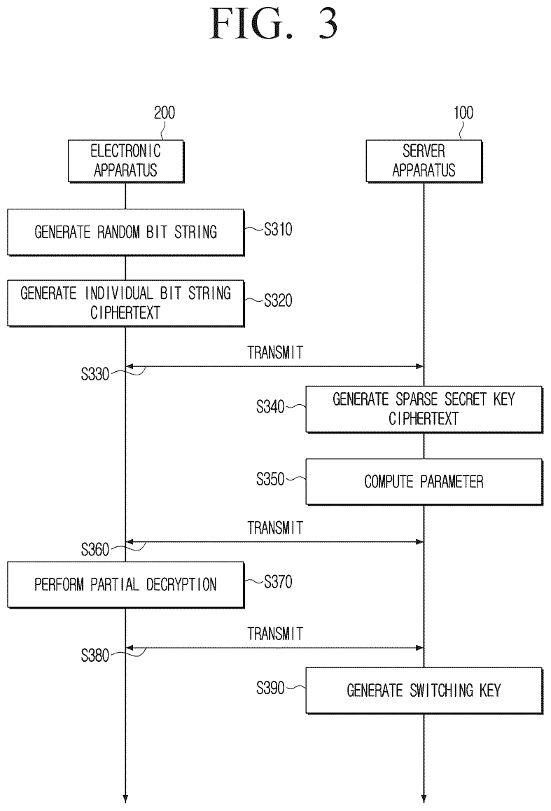

The server apparatus 100 may communicate with the electronic apparatuses 200 to generate a first switching key and a second switching key to be used for bootstrapping. Details thereof will be described below with reference to FIG. 3.

Meanwhile, in CKKS-based homomorphic operation, operation keys (evaluation keys), such as rotation keys, conjugate keys, and multiplication keys, are key keys that determine the efficiency of server-side homomorphic operation. However, from the perspective of electronic apparatuses (e.g., mobile devices, IoT devices), the cost for generating and transmitting these operation keys may be excessive. For example, depending on the bootstrapping configuration, the size of a bootstrapping key including a plurality of rotation keys or the like may become very large (e.g., several GBs), and thus the burden on the computation, transmission, and storage resources of a terminal may become a bottleneck for practicality.

Therefore, instead of a method in which an electronic apparatus “directly generates and transmits”operation keys, the present disclosure utilizes a structure in which a significant portion of operation key generation is delegated to and provided by a key generating server, in a manner that reduces the burden on the terminal without significantly degrading the homomorphic operation throughput.

To this end, the electronic apparatus may provide the key generating server with a ciphertext (e.g., ENC_PKsk) obtained by homomorphically encrypting the secret key sk generated by the electronic apparatus with the global public key PK, and the key generating servers may then generate ciphertexts (e.g., ENC_PKPK, ENC_PKEVK) for pk and evk by using the ciphertext, perform threshold-decryption to produce pk and evk, and broadcast or provide the pk and evk to a computing server.

At this time, the server apparatus may process a polynomial and an error polynomial required for the operation key (e.g., key switching key/relinearization key) generating process against the CRT (RNS)-based modulus set (qᵢ). At this time, a reduction to the modulus qᵢ may be performed using a scale factor (Q/qᵢ) for the current modulus Q, and if the number of RNS primes is large (e.g., 30), a method in which the terminal directly provides all types of ciphertexts may actually increase costs.

Therefore, the server apparatus may utilize a method (a so-called CKKS-BFV continuum) that derives the ciphertexts in the form of a BFV required for CRT operation from a single CKKS ciphertext (e.g., a CKKS ciphertext with sk as a decryption result) provided by the electronic apparatus.

In addition, various modifications may be made to reduce communication and computational load. For example, in the case of a rotation key, the required term may be in the form φ(s). The server apparatus may be configured to generate ENC (P·φ(s)) on the server side using ENC (P·s) and a global operation key EVK and to perform only one key switching operation for each rotation key, thereby reducing the transmission burden on the terminal.

In addition, depending on the tradeoff between communication costs and server-side efficiency, the server apparatus 100 may be configured to bootstrap and clean the received CKKS ciphertext before use.

Such a configuration may reduce the burden of generating and transmitting the operation key on the terminal, while maintaining the security of the user's secret key, as long as a threshold (t) or more of the key generating servers do not collide.

As described above, a network system according to the disclosure may generate sparse secret key ciphertext using a random bit string ciphertext provided by individual electronic apparatuses, even in a threshold cryptographic environment in which a plurality of participants possess in a distributed manner a secret key.

In addition, it is possible to generate and provide operation keys in a form that alleviates the burden on electronic apparatuses while not significantly reducing homomorphic operational throughput.

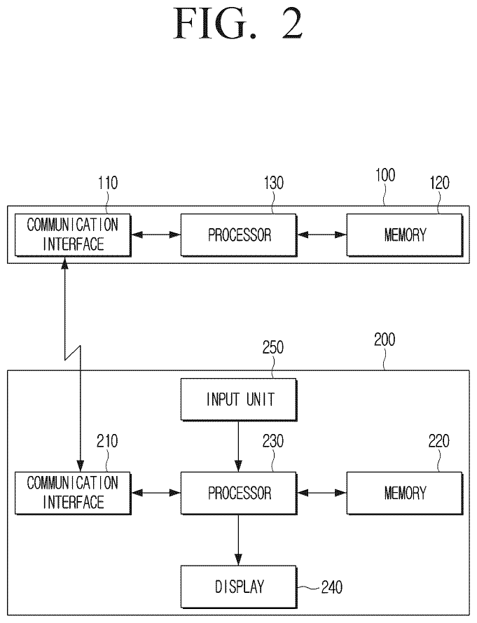

FIG. 2 is a block diagram illustrating a configuration of a server apparatus and an electronic apparatus according to at least an embodiment of the disclosure.

According to FIG. 2, the server apparatus 100 includes a communication interface 110, a memory 120, and a processor 130.

The communication interface 110 is configured to communicate with various external devices including the electronic apparatus 200.

The communication interface 110 may transmit and receive various signals and data to and from external devices via various wired and wireless communication methods, such as a wired/wireless local area network (LAN), a wide area network (WAN), Ethernet, IEEE 1394, Bluetooth, AP-based Wi-Fi (Wi-Fi, Wireless LAN network), Zigbee, high-definition multimedia interface (HDMI), universal serial bus (USB), mobile high-definition link (MHL), audio engineering society/European broadcasting union (AES/EBU), optical, and coaxial. For example, the communication interface 110 may receive a homomorphic ciphertext, various keys, operation requests, etc. from the respective electronic apparatuses 200-1 to 200-n of FIG. 1, and transmit operation results of the homomorphic ciphertext to the respective electronic apparatuses 200-1 to 200-n.

The memory 120 is configured to store various programs, data, instructions, etc. required for the operation of the server apparatus 100. The memory 120 may be implemented as at least one of various memories, such as dynamic random access memory (DRAM), static RAM (SRAM), synchronous dynamic RAM (SDRAM), one-time programmable ROM (OTPROM), programmable ROM (PROM), erasable and programmable ROM (EPROM), electrically erasable and programmable ROM (EEPROM), mask ROM, flash ROM, flash memory, a hard drive, or a solid state drive (SSD).

The memory 120 may store various homomorphic ciphertexts received through the communication interface 110, as well as operation keys, switching keys, public keys, etc. used in calculations thereof. In addition, the memory 120 may store various Equations or instructions necessary for generating sparse secret keys and public keys of a preset size or smaller. Alternatively, the memory 120 may store at least one artificial intelligence model capable of processing homomorphic ciphertexts, along with data and programs for training the model.

The processor 130 is a component for controlling the overall operation of the server apparatus 100. The processor 130 may perform various operations based on the instructions, programs, data, etc. stored in the memory 120.

The processor 130 may be implemented as a digital signal processor (DSP) for processing digital signals or a microprocessor. However, the processor is not limited thereto and may include one or more of, or be defined by, a central processing unit (CPU), a microcontroller unit (MCU), a micro-processing unit (MPU), a controller, an application processor (AP), a communication processor (CP), an ARM processor, a graphics processing unit (GPU), a neural processing unit (NPU), or an artificial intelligence (AI) processor. In addition, the processor 130 may be implemented as a system on chip (SoC), a large-scale integration (LSI), or a field programmable gate array (FPGA) with built-in processing algorithms.

The CPU, as a general-purpose processor capable of performing not only general operations but also artificial intelligence operations, may efficiently execute complex programs through a multi-layer cache structure. The CPU is advantageous in serial processing, enabling an organic linking of previous and subsequent calculation results through sequential calculations.

The GPU, as a processor for mass computation, such as floating-point operations used in graphics processing, may perform large-scale operations in parallel by integrating a massive number of cores. In particular, the GPU may be more advantageous than the CPU for parallel processing methods, such as convolution operations. In addition, the GPU may be used as a co-processor to complement the functions of the CPU.

The NPU is a processor specialized for AI operation using artificial neural networks, in which each layer of an artificial neural network may be implemented in hardware (e.g., silicon). In this case, since an NPU is specifically designed according to an enterprise's required specifications, it has a lower degree of freedom compared to the CPU or the GPU, but may efficiently process AI operations requested by the enterprise. Meanwhile, as a processor specialized for AI operations, the NPU may be implemented in various forms, such as a tensor processing unit (TPU), an intelligence processing unit (IPU), a vision processing unit (VPU), and the like. Unless specified as the aforementioned NPU, an AI processor is not limited to the examples described above.

In addition, the processor 130 may be implemented as a system-on-chip (SoC). In this case, the SoC may include one or more processors 130 as well as the memory 120 and may also include a bus for data communication between the memory 120 and the processor 130.

Based on an operation request received from the electronic apparatus 200 via the communication interface 110 or the occurrence of a preset event, the processor 130 may perform an operation on at least one homomorphic ciphertext stored in the memory 120 and provide the operation result to the electronic apparatus 200 in a homomorphically encrypted form.

Here, the preset event may include the arrival of a preset time period, the receipt and storage of a new homomorphic ciphertext, or an update to an existing homomorphic ciphertext. For example, based on a user transmitting a homomorphic ciphertext of personal information and requesting to verify whether the corresponding personal information is registered, the processor 130 may perform an inner product operation between pre-stored homomorphic ciphertexts and the received homomorphic ciphertext, collect the operation results, and transmit the collected results to the electronic apparatus 200. In addition, the type of operation performed on the homomorphic ciphertext may vary depending on the user's request.

Based on the operation result being transmitted to the electronic apparatus 200, the electronic apparatus 200 may decrypt the operation result and provide the operation result to the user.

The electronic apparatus 200 may be implemented in various forms. For example, based on the electronic apparatus 200 being implemented as an apparatus with which a display is integrated, such as a smartphone or tablet PC, the electronic apparatus 200 may include a communication interface 210, a memory 220, a processor 230, a display 240, and an input unit 250, as illustrated in FIG. 2.

The general operations and examples of the communication interface 210, the memory 220, and the processor 230 are identical or similar to those of the server apparatus 100 described above, and therefore, a detailed description thereof will be omitted.

The communication interface 210 may transmit individual bit string ciphertexts to the server apparatus 100. In addition, the communication interface 210 may receive parameters from the server apparatus 100 and, in response, transmit partial decryption results to the server apparatus 100.

Here, the partial decryption refers to an operation in a threshold-based decryption structure in which a plurality of decryption participants (e.g., a plurality of electronic apparatuses) perform a partial decryption operation on the ciphertext using portions of their respective secret keys (e.g., divided shares of the secret key) and output the result (a partial decryption result). The partial decryption result alone cannot restore the plaintext, but the plaintext may be restored when a plurality of partial decryption results are combined.

The memory 220 may store individual secret keys used in the electronic apparatus 200, random bit strings corresponding to individual bit string ciphertexts, and the like. In addition, the memory 220 may store a global public key.

The display 240 is configured to display various user interface (UI) screens. As described above, based on the operation results for the homomorphic ciphertext transmitted from the server apparatus 100 being received via the communication interface 210, the processor 230 may decrypt the operation results using the secret key stored in the memory 220 and then display the same on the display 240.

The input unit 250 is configured to input various user commands. If the electronic apparatus 200 is implemented as a smartphone or tablet PC, the input unit 250 may be implemented as a touch screen integrated with the display 240. However, without being limited thereto, the input unit 250 may also be implemented as buttons, a touch pad, or the like. Alternatively, in the case of an electronic apparatus 200 capable of voice recognition, the input unit 250 may include a microphone.

If the user inputs a user command requesting the storage of specific information in the server apparatus 100 via the input unit 250, the processor 230 may homomorphically encrypt the corresponding information.

Homomorphic encryption may be implemented using various schemes. While the various embodiments of the disclosure describe homomorphic encryption using the Cheon-Kim-Kim-Song (CKKS) scheme, the disclosure is not limited thereto and may be implemented using various other schemes.

To perform homomorphic encryption, various keys, such as public and secret keys, are required. The processor 230 or processor 130 may generate these keys directly or receive them from an external device and use the same. For convenience of explanation, a general key generating operation is described, and then a global secret key generating operation and a sparse secret key generating operation according to the present disclosure are described.

If the electronic apparatus 200 generates its own key, the processor 230 may generate a public key using the Ring-LWE technique. Specifically, the processor 230 may first set various parameters and rings and store them in memory 220. Examples of parameters may include the length of plaintext message bits, a dimension (n), a rank (k), and sizes of the public and secret keys. There are various formats for homomorphic ciphertexts, and the processor 230 may set a ring according to a ciphertext scheme based on a method set by the user or a predetermined method. For example, the aforementioned homomorphic ciphertext scheme may be a CKKS scheme, an RLWE scheme, etc.

A ring may be expressed by Equation 3 below:

$$R = {Z}_{q} [ X ] / f ( x ) \qquad [ Equation 3 ]$$

Here, R is a ring, Zq is a coefficient, and f(x) is an n-th polynomial.

The ring is a set of polynomials with preset coefficients, in which addition and multiplication are defined between elements and the set is closed under addition and multiplication.

As an example, the ring refers to a set of n-th polynomials with coefficients Zq. Specifically, when n is Φ(N), it refers to an N-th cyclotomic polynomial. (f(x)) represents an ideal of Zq[x] generated by f(x). The Euler totient function Φ(N) refers to the number of natural numbers that are coprime to N and less than N. If ΦN(x) is defined as an N-th cyclotomic polynomial, the ring may also be expressed as Equation 4 below.

$$R = {ℤ}_{q} [ x ] / ( {Φ}_{N} ( x ) ) \qquad [ Equation 4 ]$$

The ring R of Equation 4 described above has complex numbers in the plaintext space.

To improve the operation speed for homomorphic ciphertexts, only a set whose plaintext space is a real number among the aforementioned set of rings may be used. Once the ring is set, the processor 230 may derive a secret key sk from the ring. The secret key sk may be expressed as follows:

$$s k ← ( 1 , s ( x ) ) , s ( x ) ∈ R \qquad [ Equation 5 ]$$

Here, s (x) refers to a randomly generated polynomial with small coefficients. Since the secret key sk may be composed of a polynomial of s, the secret key sk may also be referred to as s in this disclosure.

The processor 230 then calculates a first random polynomial (a (x)) from the ring. The first random polynomial may be expressed as follows:

$$a ( x ) ← R \qquad [ Equation 6 ]$$

In addition, the processor 230 may calculate an error. Specifically, the processor 230 may extract the error from a discrete Gaussian distribution or a distribution with a statistically close distance thereto. The error may be expressed as follows:

$$e ( x ) ← {D}_{α q}^{n} \qquad [ Equation 7 ]$$

Once the error is calculated, the processor 230 may perform a modular operation on the error with the first random polynomial and the secret key to calculate a second random polynomial. The second random polynomial may be expressed as follows:

$$b ( x ) = - a ( x ) s ( x ) + e ( x ) ( mod q ) \qquad [ Equation 8 ]$$

Finally, the public key PK is set in the form including the first and second random polynomials, as follows.

$$pk = ( b ( x ) , a ( x ) ) \qquad [ Equation 9 ]$$

The contents of Equations 3 to 9 described above are examples of using the CKKS scheme (i.e., the RLWE scheme). In the case of using the LWE or MLWE scheme, the aforementioned method may be modified to suit the corresponding scheme. In addition, it is of course possible to generate the public and secret keys using other methods besides the above-described methods.

According to various embodiments of the disclosure, the processor 230 may generate a local secret key. However, if a sparse secret key is constructed by simply adding the local secret keys generated by each electronic apparatus, sparsity may not be guaranteed. Accordingly, in the disclosure, instead of directly providing a local secret key, each processor 230 may generate individual bit string ciphertexts and control the communication interface 210 to transmit the generated individual bit string ciphertexts.

Here, each individual bit string ciphertext may be obtained by homomorphically encrypting a random bit string with a global public key. Each individual bit string is a bit string having a preset number of bits and may be sampled to have a statistically uniform distribution among the individual bit strings provided by the plurality of electronic apparatuses.

In addition, the processor 230 may control the communication interface 210 to receive a parameter necessary for generating the first switching key and the second switching key, generate a partial decryption result using the received parameter, and transmit the generated partial decryption result.

Based on the individual bit string ciphertexts, obtained by homomorphically encrypting a random bit string, from each of the plurality of electronic apparatuses, the processor 130 performs a homomorphic operation on the received individual bit string ciphertexts to generate a sparse secret key ciphertext corresponding to the sparse secret key. For example, the processor 130 may perform a homomorphic addition on the received individual bit string ciphertexts to generate a global random bit string ciphertext corresponding to the sum of random bit strings provided by a plurality of electronic apparatuses.

The processor 130 may generate a mask vector ciphertext corresponding to a mask vector for selecting a predetermined number of bits by using the global random bit string ciphertext and obtain a sparse secret key ciphertext using the mask vector ciphertext and the global random bit string ciphertext. Here, the mask vector may be a vector in which only one of a plurality of components has a value, while the remaining components are set to 0.

The processor 130 may perform a homomorphic operation of applying a random sign to the mask vector ciphertext to generate a sparse secret key ciphertext including, as a plaintext, a ternary vector in which only a preset number of components among a plurality of components have a value among {-1, 1}, and the remaining components have a value of 0. At this time, the processor 130 may generate a plurality of mask vector ciphertexts and repeatedly perform homomorphic multiplication and homomorphic addition operations based on a corresponding random sign for each of the plurality of mask vector ciphertexts to generate a sparse secret key ciphertext.

The processor 130 may generate a first switching key for converting a first homomorphic ciphertext into a second homomorphic ciphertext corresponding to the sparse secret key based on the sparse secret key ciphertext. For example, the processor 130 may generate a parameter representing a portion of the ciphertext coefficients corresponding to the sparse secret key ciphertext and control the communication interface 110 to transmit the generated parameter to a plurality of electronic apparatuses.

For example, the sparse secret key ciphertext may be a homomorphic ciphertext expressed as the coefficients of at least one polynomial, and the processor 130 may extract one or more coefficient values corresponding to a predetermined index among polynomial coefficients of the sparse secret key ciphertext and compute the parameter by performing at least one of a division operation by a predetermined scaling factor or a rounding operation on the extracted coefficient values.

Based on partial decryption results received from the plurality of electronic apparatuses, the processor 130 may additionally generate a second switching key for converting a second homomorphic ciphertext corresponding to the sparse secret key into a first homomorphic ciphertext corresponding to the global secret key, based on the received partial decryption results and the sparse secret key ciphertext (and, if necessary, the first switching key). For example, the partial decryption results may include flood noise. Accordingly, the processor 130 may sum the partial decryption results, perform normalization and decoding on the summed results to derive intermediate parameters, and generate first and second switching keys based on the sparse secret key ciphertext and intermediate parameters.

Here, flood noise refers to random noise intentionally added to prevent the secret key or an intermediate value from being exposed during the partial decryption results or a combination process thereof. For example, the flood noise may be selected to have a statistically sufficient size (or variance) to make it difficult to estimate a participant's secret key share or related information from the partial decryption results. The flood noise may be applied under predetermined conditions to minimize the impact on the accuracy of the final decryption result.

Once the first and second switching keys are generated, if bootstrapping for a homomorphic ciphertext is required, the processor 130 may convert a first homomorphic ciphertext into a second homomorphic ciphertext corresponding to a sparse secret key using the first switching key, perform bootstrapping on the second homomorphic ciphertext, and convert the bootstrapped second homomorphic ciphertext into a first homomorphic ciphertext corresponding to a global secret key using the second switching key.

As described above, the server apparatus according to the disclosure may generate sparse secret key ciphertext using random bit string ciphertext provided from individual electronic apparatuses, even in a threshold cryptographic environment in which a plurality of participants in a distributed manner secret keys. In addition, by using such a sparse secret key ciphertext, there is an effect that high-speed bootstrapping may be implemented.

In addition, the processor 230 may not directly generate the operation key used for bootstrapping but may instead use another device.

For example, after generating its own secret key sk, the processor 230 may control the communication interface 210 to transmit a ciphertext (e.g., ENC_PKsk) obtained by homomorphically encrypting the secret key with a global public key PK to the server apparatus 100.

In this case, the processor 130 of the server apparatus 100 may generate ciphertext (e.g., ENC_PKPK, ENC_PKEVK) for the public key PK and the operation key EVK using use ENC_PKsk, calculate pk and evk through threshold decryption (e.g., t-out-of-n distributed decryption), and then broadcast the same or may store the homomorphic operation described below for use or transmit the same to another device.

At this time, in the process of generating an operation key (e.g., a key switching key, a relinearization key, an automorphism key, etc.), the processor 130 may process polynomials, error polynomials, etc. in a large modulus (PQ), but may decompose and process them into operations in a plurality of small modulus sets (qᵢ) based on CRT (RNS) for operation efficiency.

Although the server device 100 and the electronic apparatus 200 have been illustrated and described based on the basic configurations, in actual implementation, various components may be additionally provided in addition to the aforementioned components.

FIG. 3 is a sequence diagram illustrating a key generating operation according to an embodiment of the disclosure.

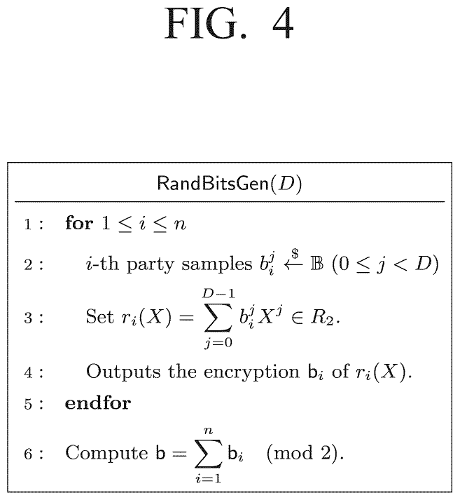

Referring to FIG. 3, each electronic apparatus 200 may generate a bit string having a preset number of bits (S310). These individual bit strings have a preset number of bits, and each bit is randomly selected to take one of the values {0, 1} and, the bit strings are sampled such that the entire set of individual bit strings provided by different electronic apparatuses have a statistically uniform distribution. Such an individual bit string may be referred to as a random bit string. A specific algorithm for generating the individual bit string will be described below with reference to FIG. 4.

Once the individual bit strings are generated, each electronic apparatus 200 may homomorphically encrypt the individual bit strings (S320). For example, each electronic apparatus 200 may homomorphically encrypt individual random bit strings using a global public key.

By generating homomorphic ciphertexts for the random bit strings in this manner, the electronic apparatuses 200 may transmit the individual bit string ciphertexts to the server apparatus 100 (S330).

Upon receiving the individual bit string ciphertexts obtained by homomorphically encrypting random bit strings from a plurality of electronic apparatuses, the server apparatus 100 may perform homomorphic operations on the received individual bit string ciphertexts to generate sparse secret key ciphertexts corresponding to the sparse secret key (S340).

For example, the server apparatus 100 may perform a homomorphic addition on the received individual bit string ciphertexts to generate a global random bit string ciphertext corresponding to the sum of random bit strings provided by a plurality of electronic apparatuses, generate a mask vector ciphertext corresponding to a mask vector for selecting a predetermined number of bits by using the global random bit string ciphertext, and obtain a sparse secret key ciphertext by using the mask vector ciphertext and the global random bit string ciphertext.

Here, the mask vector may be a vector in which only one of a plurality of components has a value, while the remaining components are set to 0. In addition, a homomorphic operation that applies a random sign to the mask vector ciphertext may be performed to generate a sparse secret key ciphertext including a ternary vector as its plaintext, in which only a predetermined number of components have a value among {-1, 1} and the remaining components have a value of 0. In this case, the server apparatus may generate a plurality of mask vector ciphertexts and repeatedly perform homomorphic multiplication and homomorphic addition operations based on the corresponding random signs for each of the plurality of mask vector ciphertexts to generate the sparse secret key ciphertext.

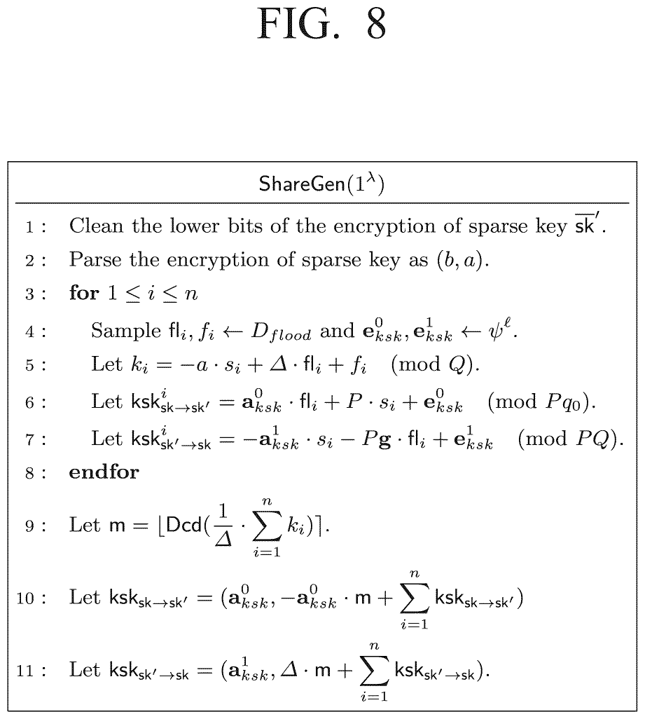

The server apparatus 100 may generate parameters representing a portion of a ciphertext coefficient corresponding to the sparse secret key ciphertext (S350) and transmit the generated parameter to a plurality of electronic apparatuses 200 (S360). For example, the server apparatus 100 may extract one or more coefficient values corresponding to a predetermined index among polynomial coefficients of the sparse secret-key ciphertext, and compute the parameter by performing at least one of a division operation by a predetermined scaling factor or a rounding operation on the extracted coefficient values. More detailed operations are described below with reference to FIG. 8.

Each electronic apparatus 200 that receives the parameter may perform partial decryption (S370) and transmit the corresponding partial decryption result to the server apparatus 100 (S380). The specific partial decryption operation is described below with reference to FIG. 8.

The server apparatus 100 that receives the partial decryption result may generate a first switching key and a second switching key using the received partial decryption result and the previously generated sparse secret key ciphertext (S390). For example, the partial decryption result may include flood noise. Therefore, the server apparatus 100 may sum the partial decryption results, perform normalization and decoding on the sum result to derive an intermediate parameter, and generate the first switching key and the second switching key based on the sparse secret key ciphertext and the intermediate parameter.

As described above, according to the key generating method according to the disclosure, even in a threshold cryptographic environment in which a plurality of participants in a distributed manner secret keys, sparse secret key ciphertext may be generated using random bit string ciphertext provided from an individual electronic apparatus. In addition, by utilizing the sparse secret key ciphertext, high-speed bootstrapping may be implemented.

Meanwhile, although the case of using a single secret key has been described above, two types of secret keys may be used in actual implementation. For example, the sparse secret key encapsulation according to the disclosure may be a method of using both a less-sparse secret key having a relatively large Hamming weight and a sparse secret key having a very small Hamming weight.

That is, the less-sparse secret key may be used during routine encryption/decryption or homomorphic operations, while the sparse secret key may be used only temporarily during the bootstrapping process. In addition, to switch between the less-sparse secret key and sparse secret key, (i) a switching key (low modulus level) that encrypts the less-sparse secret key under the sparse secret key, and (ii) a switching key (high modulus level) that encrypts the sparse secret key under the less-sparse secret key may be provided.

FIG. 4 is a diagram illustrating an operation of generating a random bit string according to an embodiment of the disclosure.

Hereinafter, it is assumed that the Hamming weight of a ternary vector of length N (i.e., a vector with component values −1, 0, and 1) is h, and that the goal is to ensure that the positions of non-zero components (i.e., −1 and 1) follow a uniform distribution.

The simplest method to achieve the assumption is to randomly select an index, assign 1 or −1 to that position with probability of ½, and repeat until the total Hamming weight reaches h. Since redundant indices may occur, this algorithm may terminate after H iterations with a high probability for a certain integer (H>=h).

The number of random bits required here is H(log N+1). This is because selecting a random index among N indices requires log N bits of randomness, and 1 bit is additionally required to determine whether to use 1 or −1 at the corresponding position. Hereinafter, this is denoted as D=H(log N+1). FIG. 4 illustrates an algorithm for generating a random bit string of length D.

Referring to FIG. 4, specifically, referring to the second column of the algorithm, a bit string (bᵢ) of length D may be sampled for each participant. That is, by uniformly randomly sampling the bit string consisting of D bits so that each bit has a value of either −1 or 1, an individual random bit string (bᵢ) for a specific participant may be generated.

Meanwhile, referring to the third column of the algorithm, once the individual random bit string (bᵢ) is generated, an individual polynomial (rᵢ(X)) may be generated using the generated individual random bit string (bᵢ). That is, the polynomial (rᵢ(X)) with the aforementioned individual random bit string as a coefficient may be generated.

Referring to the fourth column of the algorithm, a ciphertext (bᵢ) corresponding to the polynomial may be generated using the generated individual polynomial (rᵢ(X)). For example, the ciphertext may be generated using a method, such as bᵢ=Enc(rᵢ(X)).

The global ciphertext (b) may be generated by repeating this process for the number of participants and adding the ciphertexts (bᵢ) of each participant, as shown in a sixth line of the algorithm,.

Here, b is the ciphertext of the global random bit string or the global ciphertext, obtained by adding the ciphertexts of each participant. Since the bit strings contributed by all parties are synthesized in the ciphertext state, no single participant may control the entire bit string.

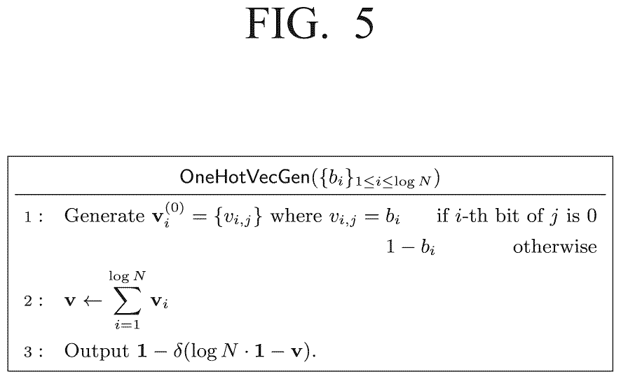

As previously explained, local information of each participant may not directly have sparse patterns. However, by homomorphically sampling the mask vector and a one-hot vector used to generate the mask vector from the global ciphertext in a later stage, the finally generated global secret key may have a sparse value. The specific operation for generating the one-hot vector and the mask vector are described below with reference to FIG. 5.

FIG. 5 is a diagram illustrating an operation of generating a mask vector.

A mask vector is a selector vector for selecting only components corresponding to specific coordinates (bits or indices) from among the entire vector of length N and may be generated by adding a plurality of one-hot vectors together by a preset number corresponding to the Hamming weight (h). Here, the Hamming weight refers to the number of non-zero components.

The one-hot vector is a vector in which only one position is 1 and all other positions are 0 and may be expressed, for example, as in Equation 10 below.

$$e = ( 0 , 0 , … , 0 , 1 , 0 , \text{…} , 0 ) \qquad [ Equation 10 ]$$

Here, the index with the value 1 may be referred to as a location of the non-zero component, and through this index, the coordinate to be selected may be designated.

The process of generating a plurality of one-hot vectors (e.g., H) may be implemented in a batch manner. For example, by configuring the one-hot vector generation and δ(·) evaluation for a plurality of indices to be performed in parallel, the required number of rotation operations may be reduced compared to repeating individual rotation operations.

Hereinafter, a method for generating a one-hot vector in which an index having a non-zero component (value 1) follows a uniform distribution in the interval [0, N) is illustrated. To this end, it is assumed that a one-hot vector may be generated from log N uniformly sampled bits ({bᵢ}_{i≤i≤log N}).

First, log N vectors vᵢ may be generated using log N bits as shown in Equation 11 below.

$${v}_{i} = {\{ {v}_{i , j} \}}_{i \leq i \leq log N} \qquad [ Equation 11 ]$$

Here, in the binary representation of each index (j), if the i-th bit is 0, then v_{i,j}=bᵢ may be set, and if the i-th bit is 1, then vᵢⱼ=1-bᵢ may be set. More specifically, each vector vᵢ may be expressed in a form in which a pattern (bᵢ, 1-bᵢ) is repeated according to each i-th bit of the index. For example, for i=1, 2, . . . , log N, it may be expressed as follows:

$${v}_{1} = ( {b}_{1} , 1 - {b}_{1} , {b}_{1} , 1 - {b}_{1} , … , {b}_{1} , 1 - {b}_{1} , {b}_{1} , 1 - {b}_{1} ) \qquad [ Equation 12 ]$$

$${v}_{2} = ( {b}_{2} , 1 - {b}_{2} , {b}_{2} , 1 - {b}_{2} , … , {b}_{2} , 1 - {b}_{2} , {b}_{2} , 1 - {b}_{2} )$$

$$…$$

$${v}_{logN} = ( {b}_{logN} , {b}_{l o g N} , … , {b}_{logN} , 1 - {b}_{logN} , {b}_{logN} , 1 - {b}_{logN} )$$

That is, each vector has a structure in which bᵢ or 1-bᵢ are alternately arranged depending on whether the i-th bit of index j is 0 or 1. Considering the vector

$$v := {\sum }_{i = 1}^{logN} {v}_{i}$$

obtained by adding all these vᵢ, each component of v has a value greater than or equal to 0 and less than or equal to log N, depending on how closely the binary representation of the corresponding index matches {b₁, . . . , b_{(logN)}}. In particular, at a position at which index j matches a value interpreted from the binary interpretation of (b_{(logN)} . . . b₂b₁), the component value of v is log N, while at other indices, the component value is less than log N.

Therefore, by applying the δ(·) function, defined as 1-δ(log N·1−ν), to the vector v by components, a one-hot vector, in which the position of the non-zero component is the index corresponding to the binary values b_{log N} . . . b₂b₁, may be obtained. Since each bᵢ is sampled from a uniform distribution, the binary values (b(logN) . . . b₂b₁) also follow a uniform distribution in [0, N].

Referring to FIG. 5, first, using the previously generated individual random bit strings (bᵢ), log N individual vectors (VI (⁰⁾) may be generated, and these individual vectors (VI (⁰⁾) may be summed to produce the global vector (v).

Next, by evaluating the aforementioned 8 function on the generated global vector (v), a one-hot vector in which the position of the non-zero component is the index corresponding to b_{log N} . . . b₂b₁ may be obtained. Since each bᵢ is sampled from a uniform distribution, the binary numbers b_{log N} . . . b₂b₁ also follow a uniform distribution in [0, N].

Meanwhile, to homomorphically implement the above algorithm in a homomorphic encryption environment, first, log N matrix-vector multiplications are required to generate individual vectors vᵢ, followed by a polynomial evaluation operation to approximate the δ function. The polynomial interpolation of the δ function may essentially be a polynomial of order approximately log N+1. Therefore, assuming all input randomness is included within a single ciphertext, N hoisted rotation operations and O(\sqrt{logN+1}) key-switching operations may be required to perform the algorithm.

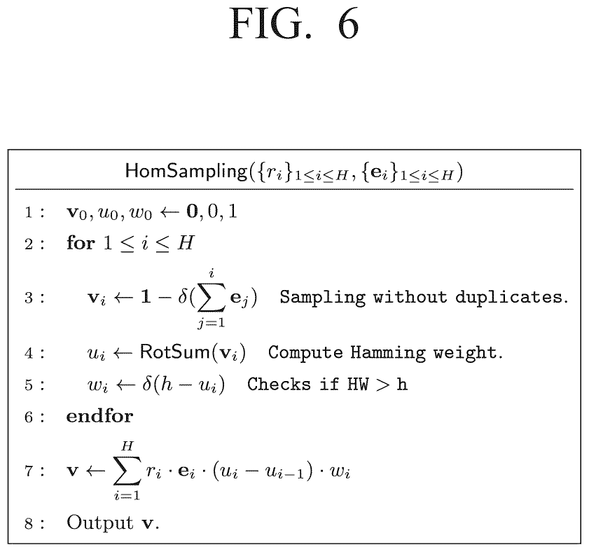

Based on the above, a method for sampling sparse vectors from a global random bit string may be implemented. The sparse vector sampling may be implemented in two ways. First, the sparse vector sampling method according to a first algorithm will be described below with reference to FIG. 6.

FIG. 6 is a diagram illustrating an example of a homomorphic sampling operation for generating a sparse secret key according to an embodiment of the disclosure. More specifically, the algorithm illustrated in FIG. 6 relates to a method for sampling a sparse secret key having a target Hamming weight by converting all random bits into one-hot vectors and then performing a homomorphic operation on the one-hot vectors as described above with reference to FIGS. 4 and 5.

Hereinafter, for simplicity, a case in which each bit has a binary value of {0, 1} is described as an example.

First, a sampling algorithm in a plaintext environment is considered. By repeating a process of uniformly sampling indices from the interval [0, N) and setting a component value of the selected index to a non-zero value (e.g., 1 or −1) is repeated until the target Hamming weight h is reached, a sparse vector with length N and Hamming weight h may be obtained. Here, letting the Hamming weight of the vector obtained in the i-th iteration be ui, if the i-th sampled index is a new index which has not been selected before, uᵢ−uᵢ−1=1, and if the previously selected index is selected again, uᵢ−uᵢ-1=0.

By defining a selector (wᵢ) using the Hamming weight (uᵢ) at each iteration stage, a distribution of a finally obtained vector may be designed to be statistically identical to a sampling algorithm in a plaintext environment.

The homomorphic sampling algorithm of the present embodiment follows the same logic as the plaintext algorithm, but performs all operations in the ciphertext state. Specifically, for each iteration i, a ciphertext corresponding to a one-hot vector eᵢ (a vector in which only a single index is 1 and all other indices are 0) is received as input, the Hamming weight ui is homomorphically calculated from the ciphertext for the cumulative sum of the one-hot vector, and a ciphertext of the selector wᵢ indicating whether ui has reached a target Hamming weight h may be calculated.

Here, the calculation of ui and wᵢ may be performed by performing rotation and accumulation operations on the vector components and homomorphically evaluating a polynomial approximation δ(·) to determine whether the Hamming weight falls within a predetermined range.

Here, δ(·) may be an integer indicator function that determines whether the input value falls within a predetermined range (e.g., an interval around a specific integer u). Since the sensitivity to approximation errors differs between a case in which the input is within the interval (interior case) or a case in which the input is close to the boundary (boundary case), different designs (e.g., different polynomial series or approximation criteria) may be applied to the approximation polynomial for 8 (·) depending on the situation. For example, in approximation-based homomorphic encryption (e.g., CKKS), since the discrimination result may become unstable when the input value is close to the boundary due to approximation errors, a configuration of securing a margin from the boundary or selecting an approximation polynomial suitable for the boundary case may be applied.

Also, in implementation, the δ(·) approximation for the interior case may be designed as a minimax approximation polynomial based on the Remez algorithm. Also, the δ(·) approximation for the boundary case may be designed to enhance numerical stability using a Chebyshev polynomial-based approximation.

With this configuration, whether a selected index is included in each iteration may be determined in a ciphertext state, and consequently, the sampling algorithm executed on the ciphertext may calculate a sparse vector having the same distribution as in a plaintext environment.

In addition, in the present embodiment, to expand binary vectors into ternary vectors, each one-hot vector e; may be multiplied by a random sign rᵢ. Here, the random sign rᵢ may be generated to have a value among {−1, 1} by calculating rᵢ=2bᵢ−1 for the random bit bᵢ. By applying the random sign, each non-zero component of the finally obtained sparse secret key takes the form of a ternary vector with a value among {-1, 1}.

Meanwhile, each coefficient of the cumulative vector obtained by repeatedly adding a plurality of one-hot vectors may have an integer value greater than or equal to 0 and less than or equal to H, and here, H represents the number of iterations and may be set such that H≥h. By evaluating a polynomial approximation of the 8 function appropriately designed for the cumulative vector, selector information representing the relationship between the number of indices selected so far and the target Hamming weight h (e.g., whether it is less than h) may be obtained from the ciphertext. By setting wᵢ based on this selector information, it is possible to reproduce the same sampling results in the ciphertext state as in the plaintext environment.

Therefore, according to the homomorphic sampling algorithm illustrated in FIG. 6, even after all random bits have been converted to one-hot vectors, by calculating the Hamming weight and selector on the ciphertext, sparse secret keys satisfying the target Hamming weight may be safely sampled even in a threshold cryptographic environment in which a plurality of participants in a distributed manner secret keys. In addition, by utilizing the sparse secret keys generated in this manner, high-speed bootstrapping may be implemented by reducing the depth of a bootstrapping circuit and decreasing the amount of operation required for bootstrapping.

In addition, by using sparse secret keys with a low Hamming weight, the probability of bootstrapping failure may be reduced, ultimately improving security and reliability.

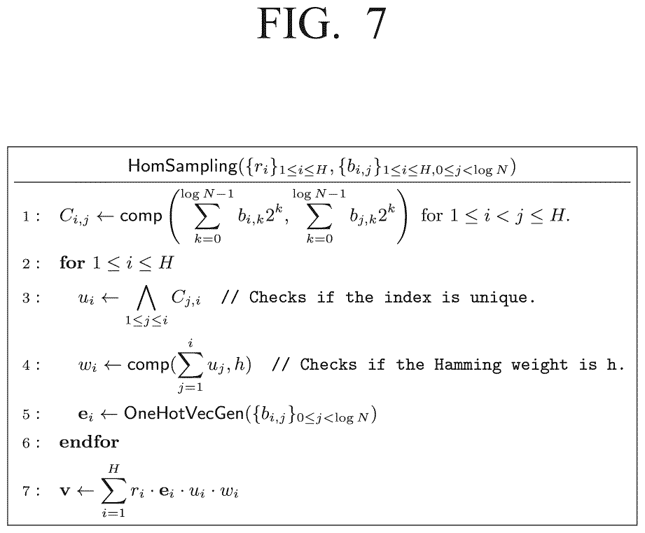

FIG. 7 is a diagram illustrating another example of a homomorphic sampling operation for generating a sparse secret key according to an embodiment of the disclosure. More specifically, the algorithm illustrated in FIG. 7 determines whether the sampled index in each iteration is a new index, similar to the method described above with reference to FIG. 6, but provide a method for sampling a sparse vector by performing a comparison operation on the random binary value corresponding to the binary representation of the index instead of directly constructing a one-hot vector.

It is assumed that the binary representation of an index {b_{i,j}}_{1≤i≤H, 0≤j<log N} is given. Here, i represents an iteration index and j represents a bit position of an index. Whether the index sampled in the i-th iteration is an index already selected in previous iterations may be determined by comparing the i-th binary vector {b_{i,j}}_{0≤j log N} with each k-th binary vector {b_{k,j}}_{0≤j<log N (1≤k<i)}.

Each comparison operation may include XOR and AND operations for corresponding bits, which may ultimately be implemented using addition and multiplication of modulo 2 (mod 2).

By combining these comparison results, a selector value (wᵢ) that outputs 1 if the i-th sampled index is a new index and outputs 0 if it is a previously selected index may be obtained.

In addition, similar to algorithm 1 described above with reference to FIG. 6, a selector indicating whether the target Hamming weight h has been reached may be homomorphically calculated for each iteration based on the number of different indices selected so far (Hamming weight).

For example, the current Hamming weight uᵢ may be homomorphically updated using the cumulative sum of the selector wᵢ, and by evaluating whether uᵢ<h through a polynomial approximation function, it may be designed to validly reflect only new indices until the target Hamming weight is reached.

Compared to the first algorithm, which directly constructs and evaluates the entire one-hot vector, the second algorithm has the advantage of performing comparison operations on binary representations of indices in parallel. That is, since comparisons between indices may be decomposed into a set of independent XOR/AND operations for each bit position, parallel processing is facilitated on a plurality of cores or vector operation units. As a result, it is advantageous in achieving the same sparse secret key distribution, while reducing the number of rotation operations and key switching operations or reducing the delay time of the overall sampling procedure.

FIG. 8 is a diagram illustrating an operation of generating a switching key according to an embodiment of the disclosure.

Referring to FIG. 8, the server apparatus 100 first prepares a sparse secret key ciphertext corresponding to a sparse secret key. The sparse secret key ciphertext may have been generated through the homomorphic sampling procedure described above with reference to FIG. 6 or 7.

The server apparatus 100 may select one or more coefficient values corresponding to a predetermined index among polynomial coefficients of the sparse secret-key ciphertext and calculate a parameter to be used for generating a switching key by applying a division operation by a predetermined scaling factor or a rounding operation on the selected coefficient values. Such a parameter may be designed to securely reflect the relationship between the sparse secret key and the global secret key.

The parameter generated in this manner may be distributed to each of the electronic apparatuses 200-1 to 200-n. For example, the server apparatus 100 may transmit the parameter to each electronic apparatus.

Each electronic apparatus 200-i may perform partial decryption using the received parameter and its own secret key (e.g., a local share of the global secret key or a local secret key in a threshold environment) or calculate a partial decryption result of the homomorphic ciphertext corresponding to the parameter.

At this time, each electronic apparatus 200 may add flood noise to its own partial decryption result. The addition of such flood noise is intended to protect the original secret information from being inferred from individual results alone and may be omitted during implementation.

Each electronic apparatus may transmit the calculated partial decryption result to the server apparatus 100.

The server apparatus 100 may additively combine the received partial decryption results (summing up all additive shares) to obtain a single sum value. This sum value may be a value indicating approximately a specific function value for the sparse secret key ciphertext.

If each electronic apparatus includes flood noise in the preceding process, the sum value may also include flood noise. In this case, the server apparatus 100 may perform normalization and decoding on the aggregated value to remove the effects of flood noise and restore a target intermediate parameter (e.g., a coefficient vector used to convert between the sparse secret key and the global secret key).

The server apparatus 100 generates the first and second switching keys using the restored intermediate parameter and the sparse secret key ciphertext.

For example, the first switching key may correspond to key switching information for converting a first homomorphic ciphertext corresponding to a global secret key into a second homomorphic ciphertext corresponding to a sparse secret key, and the second switching key may correspond to key switching information for converting the second homomorphic ciphertext back into the first homomorphic ciphertext corresponding to the global secret key.

Each switching key may be generated by combining a polynomial operation on an intermediate parameter and the sparse secret key ciphertext, noise injection, and homomorphic encryption, ensuring that the direct plaintext values of the global or sparse secret keys are not exposed externally.

Through the operation, even in a threshold cryptographic environment in which a plurality of participants in a distributed manner secret keys, the first and second switching keys based on the sparse secret key may be securely generated without exposing the secret keys of individual participants.

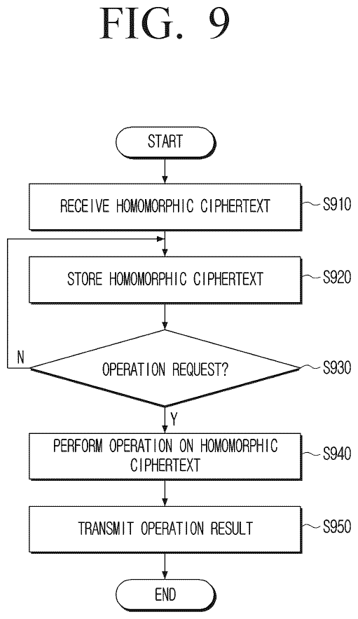

FIG. 9 is a diagram illustrating a homomorphic ciphertext processing method according to an embodiment of the disclosure.

Referring to FIG. 9, the server apparatus 100 receives and stores homomorphic ciphertext (S910, S920). In addition to the homomorphic ciphertext, the server apparatus 100 may also store various additional information used in processing the homomorphic ciphertext. For example, the server apparatus 100 may store public keys, various operation keys, switching keys, etc. in the memory 120.

In this state, based on a request for a homomorphic operation being received from a specific electronic apparatus (S930), the server apparatus 100 performs a homomorphic operation on at least one of the stored homomorphic ciphertexts (S940). The type of operation may vary depending on the contents of an operation request. For example, an inner product operation may be performed on the stored homomorphic ciphertext and a query input by the electronic apparatus but is not limited thereto.

Since the operation is performed in a homomorphic ciphertext state, the operation result also becomes a homomorphic ciphertext. The server apparatus 100 may transmit the homomorphic ciphertext corresponding to the computation result to the electronic apparatus as it is (S950). The electronic apparatus may decrypt the received homomorphic ciphertext of the operation result using a secret key and provide the decrypted plaintext result to the user.

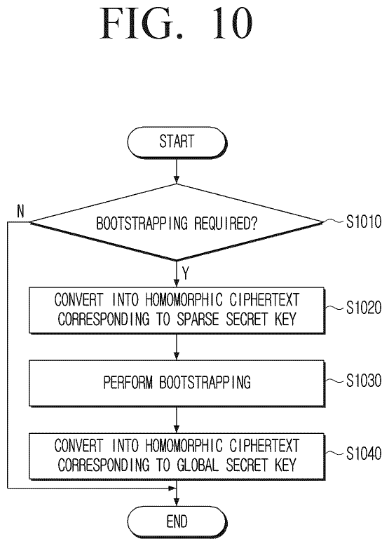

Meanwhile, based on that a modulus level of at least one homomorphic ciphertext stored in the memory 120 has fallen below a preset threshold level, the processor 130 may perform a bootstrapping operation on the corresponding homomorphic ciphertext. Here, the processor 130 may perform bootstrapping using a general bootstrapping circuit, or, as described above, may perform more efficient bootstrapping using a sparse secret key and a switching key generated based on the sparse secret key. A specific bootstrapping operation using a sparse secret key is described below with reference to FIG. 10.

FIG. 10 is a diagram illustrating a bootstrapping processing method according to an embodiment of the disclosure.

Referring to FIG. 10, the server apparatus 100 determines whether bootstrapping is necessary (S1010). Specifically, based on determining that a remaining modulus level of the homomorphic ciphertext previously stored in the memory 120 has fallen below a preset threshold level, the processor 130 of the server apparatus 100 may identify that the corresponding homomorphic ciphertext requires bootstrapping. Here, a threshold level may refer to a modulus level at which no further meaningful homomorphic operation is possible.

Based on determining that bootstrapping is necessary, the processor 130 may perform key switching using the first switching key to convert the first homomorphic ciphertext corresponding to the global secret key into a second homomorphic ciphertext corresponding to the sparse secret key (S1020).

Thereafter, the processor 130 may express the second homomorphic ciphertext in the form of a coefficient polynomial and perform a parallel operation based on valid terms corresponding to a non-zero component position of the sparse secret key, thereby performing bootstrapping on the second homomorphic ciphertext (S1030).

Based on bootstrapping being completed, the processor 130 may perform key switching using the second switching key to convert the second homomorphic ciphertext corresponding to the sparse secret key back into the first homomorphic ciphertext corresponding to the global secret key (S1040).

In this manner, the server apparatus according to at least an embodiment of the disclosure performs the bootstrapping operation using the sparse secret key and the switching key generated based thereon, thereby reducing the number of rotation and selection operations required compared to conventional methods and enabling faster and more efficient bootstrapping.

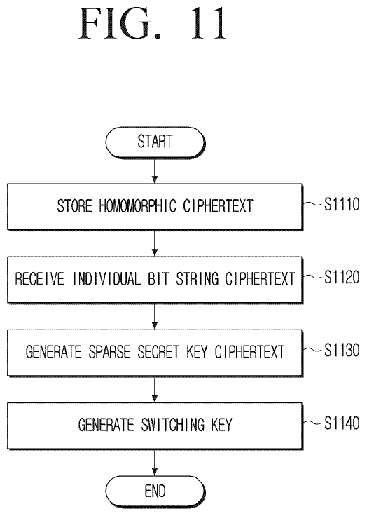

FIG. 11 is a flowchart illustrating a key generating method according to an embodiment of the disclosure.

Referring to FIG. 11, the server apparatus 100 stores a first homomorphic ciphertext homomorphically encrypted with a global public key corresponding to a global secret key (S1110).

Each of the individual bit string ciphertexts may be obtained by homomorphically encrypting a random bit string with a global public key, and the individual bit string is a bit string having a preset number of bits and may be sampled to have a statistically uniform distribution among the individual bit strings provided by a plurality of electronic apparatuses.

The server device receives, from each of a plurality of electronic apparatuses, individual bit string ciphertexts in which a random bit string is homomorphically encrypted (S1120).

The server apparatus performs a homomorphic operation on the received individual bit string ciphertexts to generate a sparse secret key ciphertext corresponding to a sparse secret key (S1130). For example, the server apparatus may perform a homomorphic addition on the received individual bit string ciphertexts to generate a globally random bit string ciphertext corresponding to the sum of random bit strings provided by a plurality of electronic apparatuses, generate a mask vector ciphertext corresponding to a mask vector for selecting a predetermined number of bits using the globally random bit string ciphertext, and obtain a sparse secret key ciphertext by using the mask vector ciphertext and the globally random bit string ciphertext.

Here, the mask vector may be a vector in which only one of a plurality of components has a value, while the remaining components are set to 0. In addition, by performing a homomorphic operation that applies a random sign to the mask vector ciphertext, the server apparatus may generate a sparse secret key ciphertext including a ternary vector as a plaintext, in which only a predetermined number of components have a value among {−1, 1} and the remaining components have a value of 0. In this case, the server apparatus may generate a plurality of mask vector ciphertexts and repeatedly perform homomorphic multiplication and homomorphic addition operations on each of the plurality of mask vector ciphertexts according to the corresponding random sign to generate the sparse secret key ciphertext.

The server apparatus generates a first switching key for converting a first homomorphic ciphertext based on the sparse secret key ciphertext into a second homomorphic ciphertext corresponding to the sparse secret key (S1140). For example, the server apparatus may generate a parameter representing a portion of the ciphertext coefficients corresponding to the sparse secret key ciphertext, transmit the generated parameter to a plurality of electronic apparatuses, and receive partial decryption results from the plurality of electronic apparatuses in response.

In this case, the sparse secret key ciphertext may be a homomorphic ciphertext expressed as the coefficients of at least one polynomial, and the server apparatus may extract one or more coefficient values corresponding to a predetermined index among polynomial coefficients of the sparse secret key ciphertext and compute the parameter by performing at least one of a division operation by a predetermined scaling factor or a rounding operation on the extracted coefficient values.

Based on the receiving of the partial decryption result described above, the server apparatus may additionally generate a second switching key for converting the second homomorphic ciphertext corresponding to the sparse secret key into the first homomorphic ciphertext corresponding to the global secret key, based on the received partial decryption result and the sparse secret key ciphertext (and, if necessary, the previously generated first switching key). For example, the partial decryption result may include flood noise. In this case, the server apparatus may sum the partial decryption results, perform normalization and decoding on a sum result to compute an intermediate parameter, and generate the first switching key and the second switching key based on the sparse secret-key ciphertext and the intermediate parameter.

The first and second switching keys generated in this manner may be used to perform key switching between the first homomorphic ciphertext corresponding to the global secret key and the second homomorphic ciphertext corresponding to the sparse secret key during the bootstrapping process described above with reference to FIG. 10, if bootstrapping of the homomorphic ciphertext is required.

In addition, the server apparatus 100 may prevent a user terminal from directly generating an operation key by using a threshold homomorphic encryption environment. For example, a threshold homomorphic encryption system capable of threshold decryption in the form of t-out-of-n may be provided, and each key generating server may have a secret key fragment (SK_i) for distributed decryption and a global public key PK and global operation key EVK for homomorphic operation.

To this end, the electronic apparatus may generate its own secret key sk, generate a ciphertext (e.g., ENC_PKsk) obtained by encrypting the corresponding secret key sk with a global public key PK, and transmits the same to the server apparatus (or a separate key generating server).

The server apparatus may perform calculations necessary to generate pk and evk based on the received ciphertext, and generate ciphertexts corresponding to pk and evk (e.g., ENC_PKPK, ENC_PKEVK) as a result.

Thereafter, the server apparatus may perform threshold decryption (partial decryption and combining) to obtain pk and evk, and broadcast or provide the obtained pk and evk to the server apparatus 100, thereby enabling the server apparatus 100 to perform homomorphic operations using the pk and evk of the user terminal.

As described above, according to the key generating method according to the disclosure, even in a threshold cryptographic environment in which a plurality of participants in a distributed manner secret keys, sparse secret key ciphertext and corresponding switching keys may be effectively generated using random bit string ciphertext provided from individual electronic apparatuses. In addition, by utilizing the sparse secret key ciphertext and switching keys, high-speed bootstrapping for homomorphic ciphertext may be implemented.

In addition, according to the key generating method of the present disclosure, the probability of bootstrapping failure may be lowered by using a sparse secret key with a low Hamming weight, thereby resultantly improving security and reliability.

While various embodiments have been described above, each embodiment is not necessarily implemented individually and may be implemented in whole or in part with at least one other embodiment and implemented together in a single product.

The various embodiments of the disclosure may be implemented as software including instructions stored on a machine-readable storage medium (e.g., a computer). The machine, which is capable of retrieving instructions stored in the storage medium and operating according to the retrieved instructions, may include the server apparatus 100 and the electronic apparatus 200 according to the disclosed embodiments.

For example, a non-transitory readable storage medium storing software for sequentially performing the various steps as illustrated in FIG. 11 may be provided.

A device equipped with such a non-transitory readable medium may perform operations, such as public key generation, encryption, and decryption described in the various embodiments described above.

In a non-transitory storage medium, “non-temporary”only means that the storage medium does not include a signal and is tangible, but does not mean that data is stored semi-permanently or temporarily in the storage medium.

Alternatively, programs for performing the method according to various embodiments described above may be distributed online through an application store. If distributed online, at least part of the computer program product may be temporarily generated or at least temporarily stored in a storage medium, such as memory of the manufacturer's server, a server of the application store, or a relay server.

In addition, each component (e.g., module or program) in the various embodiments described above may include a single entity or a plurality of entities, and some of the corresponding sub-components described above may be omitted or other sub-components may be further included in the various embodiments. Alternatively or in addition, some of the components (e.g., modules or programs) may be integrated into one entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although specific embodiments of the disclosure are shown and described hereinabove, the disclosure is not limited to the above-mentioned specific embodiments, and may be variously modified by those skilled in the art to which the disclosure pertains without departing from the scope and spirit of the disclosure as disclosed in the accompanying claims. These modifications should also be understood to fall within the scope and spirit of the disclosure.

1. A server apparatus comprising:
a communication interface configured to perform communication with a plurality of electronic apparatuses;
a memory storing at least one instruction and a first homomorphic ciphertext; and
a processor configured to execute the at least one instruction,
wherein the first homomorphic ciphertext is data homomorphically encrypted with a global public key corresponding to a global secret key; and
wherein the processor is configured to:
based on receiving individual bit-string ciphertexts obtained by homomorphically encrypting a random bit string from each of the plurality of electronic apparatuses, perform a homomorphic operation on the individual bit-string ciphertexts to generate a sparse secret-key ciphertext corresponding to a sparse secret key, and
generate a first switching key for converting the first homomorphic ciphertext into a second homomorphic ciphertext corresponding to the sparse secret key based on the sparse secret-key ciphertext.

2. The server apparatus of claim 1, wherein the processor is configured to:
homomorphically add received individual bit-string ciphertexts to generate a global random bit-string ciphertext corresponding to a sum of random bit strings provided by the plurality of electronic apparatuses;
generate a mask-vector ciphertext corresponding to a mask vector for selecting a predetermined number of bits using the global random bit-string ciphertext; and
generate the sparse secret-key ciphertext using the mask-vector ciphertext and the global random bit-string ciphertext; and
wherein the mask vector is a vector in which only one of a plurality of components has a value and remaining components are set to zero.

3. The server apparatus of claim 2, wherein the processor is configured to:
perform a homomorphic operation that applies a random sign to the mask-vector ciphertext to generate a sparse secret-key ciphertext having, as plaintext, a ternary vector in which only a predetermined number of components among a plurality of components have a value of one of {−1, 1} and remaining components have a value of zero.

4. The server apparatus of claim 2, wherein the processor is configured to:
generate a plurality of mask-vector ciphertexts, and
for each of the plurality of mask-vector ciphertexts, repeatedly perform homomorphic multiplication and homomorphic addition according to a corresponding random sign to generate the sparse secret-key ciphertext.

5. The server apparatus of claim 1, wherein the processor is configured to:
generate a parameter representing a part of ciphertext coefficients corresponding to the sparse secret-key ciphertext;
control the communication interface to transmit the parameter to the plurality of electronic apparatuses; and
based on receiving partial decryption results from the plurality of electronic apparatuses, generate the first switching key and a second switching key for converting a second homomorphic ciphertext corresponding to the sparse secret key into a first homomorphic ciphertext corresponding to the global secret key based on the received partial decryption results and the sparse secret-key ciphertext.

6. The server apparatus of claim 5, wherein the processor is configured to:
convert the first homomorphic ciphertext into the second homomorphic ciphertext using the first switching key;
perform bootstrapping on the second homomorphic ciphertext; and
convert a bootstrapped second homomorphic ciphertext into a first homomorphic ciphertext corresponding to a global secret key using the second switching key.

7. The server apparatus of claim 5, wherein the sparse secret-key ciphertext is a homomorphic ciphertext represented by coefficients of at least one polynomial; and
wherein the processor is configured to:
extract one or more coefficient values corresponding to a predetermined index among polynomial coefficients of the sparse secret-key ciphertext, and compute the parameter by performing at least one of a division operation by a predetermined scaling factor or a rounding operation on the extracted coefficient values.

8. The server apparatus of claim 5, wherein the partial decryption results include flood noise; and
wherein the processor is configured to:
sum the partial decryption results, perform normalization and decoding on a sum result to compute an intermediate parameter, and generate the first switching key and the second switching key based on the sparse secret-key ciphertext and the intermediate parameter.

9. The server apparatus of claim 1, wherein each of the individual bit-string ciphertexts is obtained by homomorphically encrypting a random bit string with the global public key.

10. The server apparatus of claim 1, wherein each of the individual bit strings is a bit string having a predetermined number of bits, and is sampled to have a statistically uniform distribution among individual bit strings provided by the plurality of electronic apparatuses.

11. A method of processing homomorphic ciphertext in a server apparatus, the method comprising:
storing a first homomorphic ciphertext homomorphically encrypted with a global public key corresponding to a global secret key;
receiving individual bit-string ciphertexts obtained by homomorphically encrypting a random bit string from each of a plurality of electronic apparatuses,
performing a homomorphic operation on the individual bit-string ciphertexts to generate a sparse secret-key ciphertext corresponding to a sparse secret key; and
generating a first switching key for converting the first homomorphic ciphertext into a second homomorphic ciphertext corresponding to the sparse secret key based on the sparse secret-key ciphertext.

12. The method of claim 11, wherein the generating a sparse secret key comprises:
homomorphically adding received individual bit-string ciphertexts to generate a global random bit-string ciphertext corresponding to a sum of random bit strings provided by the plurality of electronic apparatuses;
generating a mask-vector ciphertext corresponding to a mask vector for selecting a predetermined number of bits using the global random bit-string ciphertext; and
obtaining the sparse secret-key ciphertext using the mask-vector ciphertext and the global random bit-string ciphertext; and
wherein the mask vector is a vector in which only one of a plurality of components has a value and remaining components are set to zero.

13. The method of claim 12, wherein the obtaining the sparse secret-key ciphertext comprises:
performing a homomorphic operation that applies a random sign to the mask-vector ciphertext to generate a sparse secret-key ciphertext having, as plaintext, a ternary vector in which only a predetermined number of components among a plurality of components have a value of one of {−1, 1} and remaining components have a value of zero.

14. The method of claim 12, wherein the generating a mask-vector ciphertext comprises:
generating a plurality of mask-vector ciphertexts, and
for each of the plurality of mask-vector ciphertexts, repeatedly performing homomorphic multiplication and homomorphic addition according to a corresponding random sign to generate the sparse secret-key ciphertext.

15. The method of claim 11, further comprising:
generating a parameter representing a part of ciphertext coefficients corresponding to the sparse secret-key ciphertext;
transmitting the parameter to the plurality of electronic apparatuses,
wherein the generating a first switching key comprises:
generating the first switching key and a second switching key for converting a second homomorphic ciphertext corresponding to the sparse secret key into a first homomorphic ciphertext corresponding to the global secret key based on the received partial decryption results and the sparse secret-key ciphertext.

16. The method of claim 15, comprising:
converting the first homomorphic ciphertext into the second homomorphic ciphertext using the first switching key;
performing bootstrapping on the second homomorphic ciphertext; and
converting a bootstrapped second homomorphic ciphertext into a first homomorphic ciphertext corresponding to a global secret key using the second switching key.

17. The method of claim 15, wherein the sparse secret-key ciphertext is a homomorphic ciphertext represented by coefficients of at least one polynomial; and
wherein the generating a parameter comprises:
extracting one or more coefficient values corresponding to a predetermined index among polynomial coefficients of the sparse secret-key ciphertext, and computing the parameter by performing at least one of a division operation by a predetermined scaling factor or a rounding operation on the extracted coefficient values.

18. The method of claim 15, wherein the partial decryption results include flood noise; and
wherein the generating the first switching key comprises:
summing the partial decryption results, performing normalization and decoding on a sum result to compute an intermediate parameter, and generating the first switching key and the second switching key based on the sparse secret-key ciphertext and the intermediate parameter.

19. The method of claim 11, wherein each of the individual bit-string ciphertexts is obtained by homomorphically encrypting a random bit string with the global public key; and
wherein each of the individual bit strings is a bit string having a predetermined number of bits, and is sampled to have a statistically uniform distribution among individual bit strings provided by the plurality of electronic apparatuses.

20. A non-transitory computer-readable recording medium including a program for executing a method of processing homomorphic ciphertext, the method comprising:
storing a first homomorphic ciphertext homomorphically encrypted with a global public key corresponding to a global secret key;
receiving individual bit-string ciphertexts obtained by homomorphically encrypting a random bit string from each of a plurality of electronic apparatuses,
performing a homomorphic operation on the individual bit-string ciphertexts to generate a sparse secret-key ciphertext corresponding to a sparse secret key; and
generating a first switching key for converting the first homomorphic ciphertext into a second homomorphic ciphertext corresponding to the sparse secret key based on the sparse secret-key ciphertext.
